(19) United States
(12) Patent Application Publication
(10) Pub. No.: US 2020/0054156 A1
(43) Pub. Date: Feb. 20, 2020

(54) PROCESS OF MANUFACTURING TEARABLE TABLECLOTHS

(71) Applicant: SHIENQ HUONG ENTERPRISE CO.,LTD., Nantou County (TW)

(72) Inventor: JEN-CHI CHANG, NANTOU COUNTY (TW)

(21) Appl. No.: 16/116,657

(22) Filed: Aug. 29, 2018

(30) Foreign Application Priority Data
Aug. 17, 2018 (TW) 107128859

(51) Int. Cl. A47G 21/16; B65H 35/10; B65D 75/58

(52) U.S. Cl. CPC A47G 21/16; G06Q 50/04; B65D 75/5833; B65H 35/10

(57) ABSTRACT

A process of manufacturing tearable placemats includes selecting a quantity of textile for placemats having a predetermined width, and defining positions of a plurality of tearable lines wherein the textile for placemats in front of the tearable line is defined as an anterior textile and the textile for placemats to the rear of the tearable line is defined as a posterior textile; melting textile at the position of each tearable line; rearranging the molten tearable lines to form a textile different from both the anterior textile and the posterior textile; and keeping portions of each tearable line and cutting remaining portions of each tearable line.

### BACKGROUND OF THE INVENTION

### 1. Technical Field

The technical field relates to processes of manufacturing placemats, and more particularly relates to a process of manufacturing tearable placemats.

### 2. Description of Related Art

A tablecloth is used to protect a table and serves as an ornamental covering of the table. It can resist heat. It also protects the table from scratches and stain. Placemats have many different appearances, patterns, and colors depending on ornamental designs. Typically, placemats are made of cotton, hemp, bamboo, wood, paper, textile or plastic each having its advantages and disadvantages.

Conventional placemats are cut into rectangular shapes. Further, decorative pieces are stitched to edges of the rectangular tablecloth. The conventional placemats are produced in a piece by piece process. However, the process is labor intensive and cost ineffective. As a result, the unit price of the conventional tablecloth is relatively high.

Thus, the need for improvement still exists.

### SUMMARY OF THE INVENTION

It is therefore one object of the invention to provide a process of manufacturing tearable placemats comprising the steps of (A) selecting a quantity of textile for placemats having a predetermined width, and defining positions of a plurality of tearable lines wherein the textile for placemats in front of the tearable line is defined as an anterior textile and the textile for placemats to the rear of the tearable line is defined as a posterior textile; (B) melting textile at the position of each of the tearable lines; (C) rearranging the molten tearable lines to form a textile different from both the anterior textile and the posterior textile; and (D) keeping portions of each of the tearable lines and cutting remaining portions of each of the tearable lines.

One of the exemplary embodiments, each of the tearable lines comprises a base layer and a linking structure on the base layer, and a portion of the linking structure is kept and a connection of the base layer and the linking structure is cut when the process is performed.

One of the exemplary embodiments, a hot mold is rotatably pressed the tearable lines, and a pattern on a surface of the mold is transferred to each of the tearable lines to form the linking structure thereof when the process is performed.

One of the exemplary embodiments, 40% to 60% of a diameter or width of the linking structure is cut when the process is performed.

One of the exemplary embodiments, the linking structure is a pattern having a plurality of parallel inclined lines.

One of the exemplary embodiments, the linking structure is a criss-cross pattern.

One of the exemplary embodiments, further comprises an ultrasonic heater with the tearable lines of the textile for placemats moveably disposed thereon; and a rolling mold having a pattern configured to transfer to each of the tearable lines to form the linking structure; wherein the rolling mold rotates on the passing tearable lines of the textile for placemats with heat generated by high frequency oscillations of the ultrasonic heater being applied to the rolling mold so that the pattern of the rolling mold is configured to transfer to each of the tearable lines of the textile for placemats.

One of the exemplary embodiments, further comprises a rolling cutter including a circular blade having a plurality of cuts along an edge; wherein the rolling cutter rotates on the passing textile tearable lines of the textile for placemats with heat generated by high frequency oscillations of the ultrasonic heater being applied to the rolling cutter so that the circular blade is configured to cut the tearable lines of the textile with portions of the linking structure being uncut due to the cuts and the uncut portions of the linking structure being kept.

One of the exemplary embodiments, further comprises forming a plurality of indentations on the linking structure by edges of the cuts when the process is performed.

The invention has the following advantages and benefits in comparison with the conventional art:

Tearable placemats can be manufactured by the process of the invention without manually stitching decorative pieces to edges of the detached tablecloth. The tearable placemats can be manufactured in mass production in an automatic process with minimum labor involved and cost down. Conventional method of conveniently, quickly printing an aesthetically designed pattern, decorations, and/or letters on either surface of the placemat is applicable to the invention.

The tearable placemat manufactured by the invention can be wrapped around as a roll for facilitating mass production and for being ease of storage and transportation. A person may tear along the tearable line to easily remove one tablecloth out of the tearable tablecloth roll for use.

The above and other objects, features and advantages of the invention will become apparent from the following detailed description taken with the accompanying drawings.

### BRIEF DESCRIPTION OF THE DRAWINGS

FIG. 1 is a flowchart illustrating a process of manufacturing tearable placemats according to the invention;

FIG. 2 is a perspective view of a textile for placemats having an end being pulled out, the textile for placemats being used for the manufacture of the tearable placemats, and a tearable line of the textile for placemats being shown;

FIG. 3 is a view similar to FIG. 2 showing the rearranged tearable line after the tearable line has been molten in one embodiment;

FIG. 4 is a sectional view taken along line A-A of FIG. 3;

FIG. 5 is a view similar to FIG. 3 showing the rearranged tearable line after the tearable line has been molten in another embodiment;

FIG. 6 schematically depicts the tearable line and adjacent portions of the textile for placemats after the tearable line has been cut;

FIG. 7 is a detailed view of the area in a circle of FIG. 6;

FIG. 8 is a perspective view of a tearable tablecloth roll produced by the process of the invention, the tearable tablecloth roll having one end being pulled out;

FIG. 9 is a view similar to FIG. 8 showing the posterior textile being torn;

FIG. 10 schematically depicts an apparatus for implementing the process of manufacturing tearable placemats according to the invention;

FIG. 11 schematically depicts the rolling mold and the rolling cutter of the apparatus rotated to press and move the textile for placemats forward in performing the steps of the process of the invention;

FIG. 12 schematically shows the rolling mold; and

FIG. 13 schematically shows the rolling cutter.

### DETAILED DESCRIPTION OF THE INVENTION

Embodiments of the invention will now be described, by way of example only, with reference to the accompanying drawings.

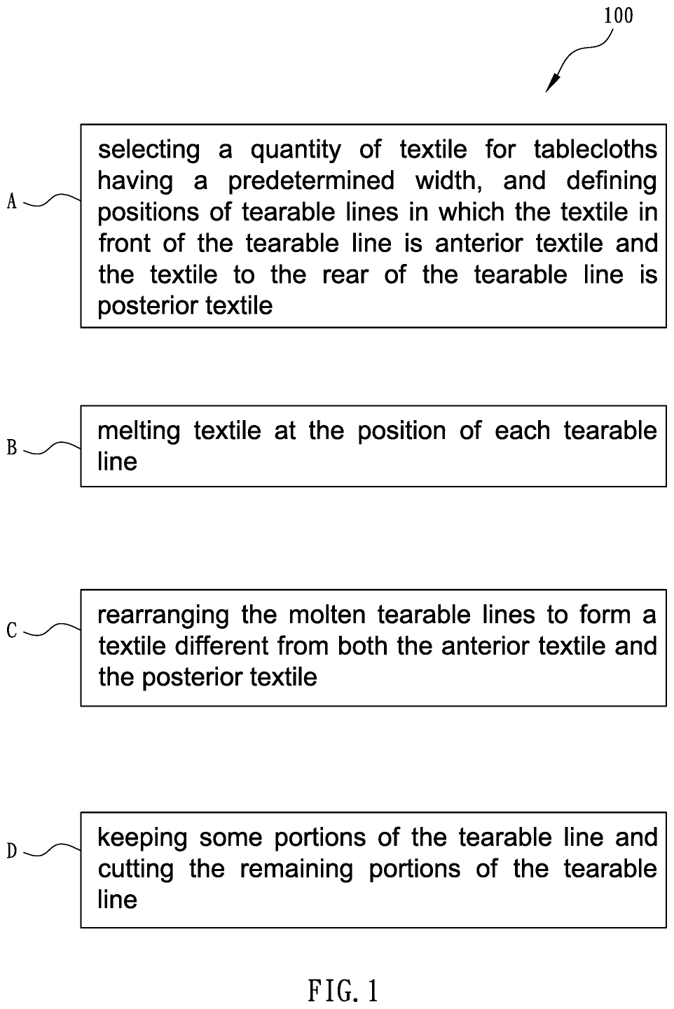

Referring to FIG. 1, a process 100 of manufacturing tearable placemats in accordance with a preferred embodiment of the invention is illustrated. While the process 100 comprises a series of steps or events, the process 100 is not limited to such. For example, some steps may be not discussed in the detailed description, and/or may not be performed the same order as discussed below, and/or may be performed concurrently with other steps or events. Further, all steps discussed below are not required to perform in one or more embodiments or concepts. Furthermore, one or more steps discussed below may be performed by one or more independent steps and/or stages.

In one embodiment, the process 100 of manufacturing tearable placemats comprises the steps of: (A) selecting a quantity of textile for placemats having a predetermined width, and defining a position of any two continuous sections the textile for placemats to be torn (i.e., one of a plurality of tearable lines) in which the textile for placemats in front of the tearable line is defined as an anterior textile and the textile for placemats to the rear of the tearable line is defined as a posterior textile; (B) melting textile at the position of the tearable line; (C) rearranging the molten tearable lines to form a textile different from both the anterior textile and the posterior textile; and (D) keeping some portions of the tearable line and cutting the remaining portions of the tearable line.

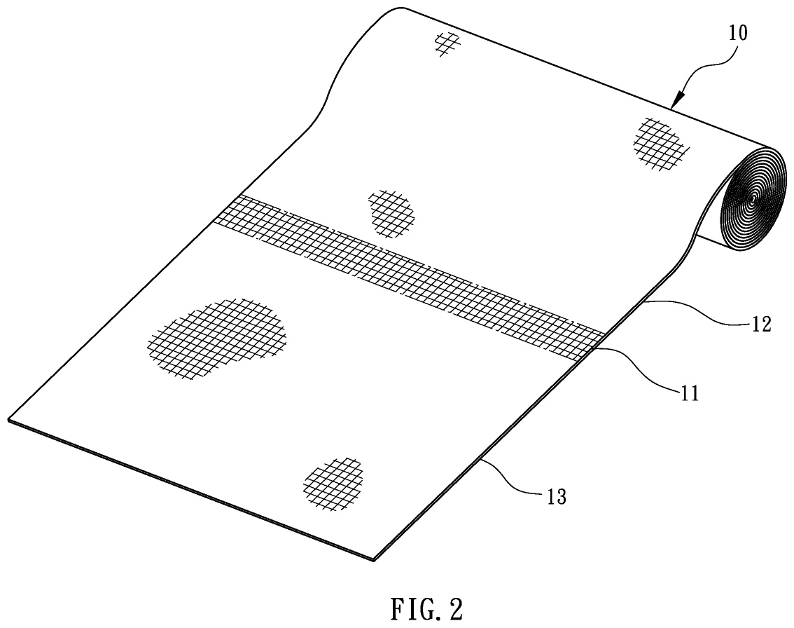

Referring to FIG. 2, in one embodiment, the process of the invention comprises the step of (A) selecting a quantity of textile 10 for placemats having a predetermined width, and defining a position of any two continuous sections the textile 10 for placemats to be torn (i.e., one of a plurality of tearable lines 11) in which the textile 10 for placemats in front of the tearable line 11 is defined as an anterior textile 12 and the textile 10 for placemats to the rear of the tearable line 11 is defined as a posterior textile 13. In the step (A), a quantity of textile 10 for placemats having a predetermined width is selected. In the embodiment, the textile is selected from one of polyester, cotton, and polyester mixed with tetoron and cotton. A position of the tearable line 11 on the textile 10 for placemats is defined, i.e., a line between two sides of the textile 10 for placemats. The anterior textile 12 is defined as the textile 10 for placemats in front of the tearable line 11, and the posterior textile 13 is defined as the textile 10 for placemats to the rear of the tearable line 11. The tearable line 11 is formed between and with the anterior textile 12 and the posterior textile 13. It is easy to tear the textile 10 for placemats along the tearable line 11 to separate the posterior textile 13 from the anterior textile 12 for use.

In one embodiment, the process of the invention further comprises the step of (B) melting the textile at the position of the tearable line 11. In detail, textile at the position of the tearable line 11 is molten by heating. The textile of the tearable line 11 is damaged. That is, warp and weft of the tearable line 11 are molten. In one embodiment, an ultrasonic heater 51 is used to melt the tearable line 11 as detailed later.

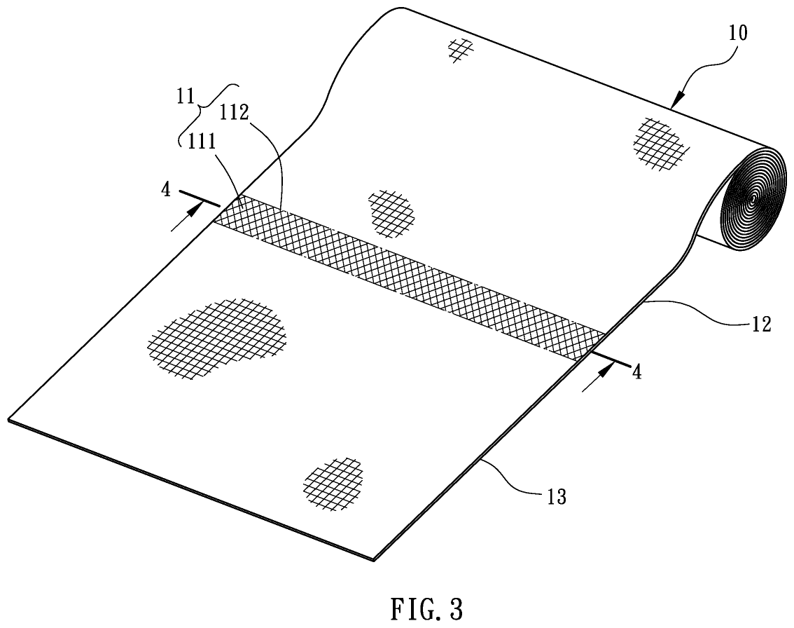

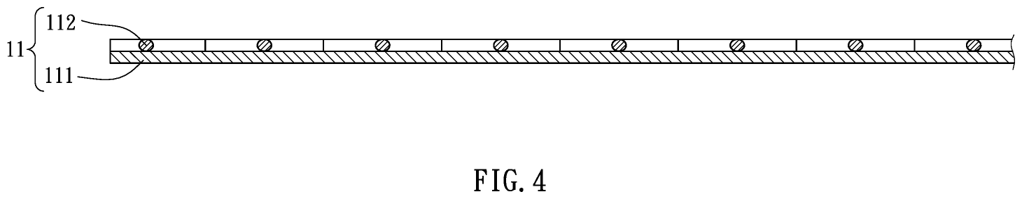

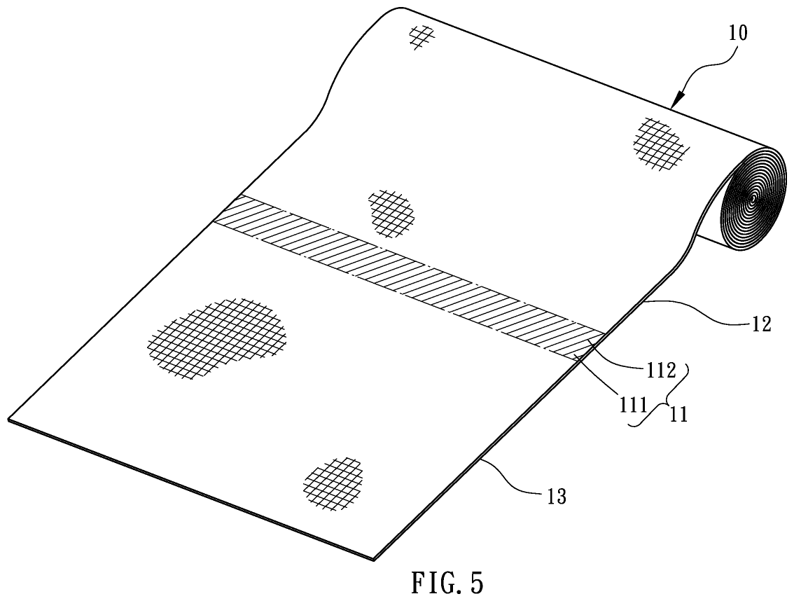

In one embodiment, the process of the invention further comprises the step of (C) rearranging the molten tearable lines 11 to form a textile different from both the anterior textile 12 and the posterior textile 13. In detail, the structure of the tearable line 11 is rearranged after has been molten. As a result, a textile different from both the anterior textile 12 and the posterior textile 13 is formed. Referring to FIGS. 3, 4 and 5, in one embodiment, the rearranged tearable line 11 comprises a base layer 111 and a linking structure 112 on the base layer 111. The linking structure 112 can be a criss-cross pattern (see FIG. 3) or a pattern having a plurality of parallel inclined lines (see FIG. 5) but not limited to such. In the embodiment, the steps (B) and (C) are performed sequentially. In another embodiment, the steps (B) and (C) are performed concurrently. Both FIGS. 3 and 5 show results after the step (C) has been performed in different embodiments respectively.

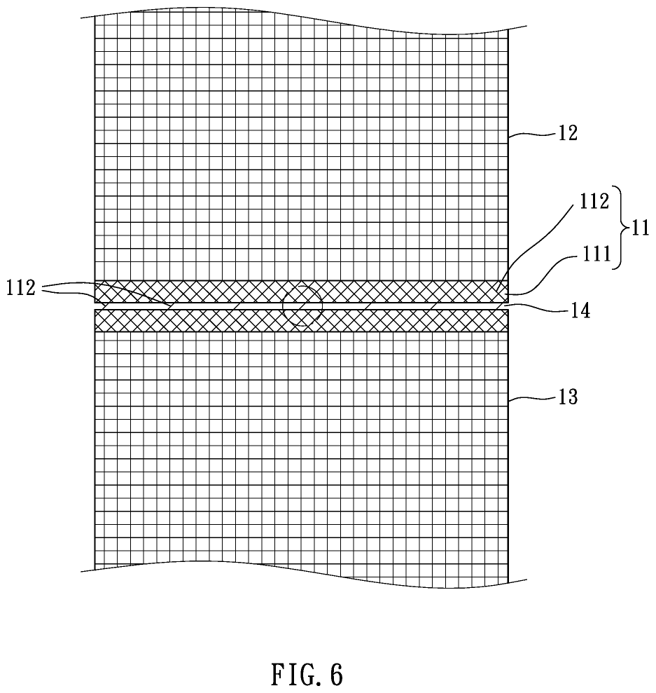

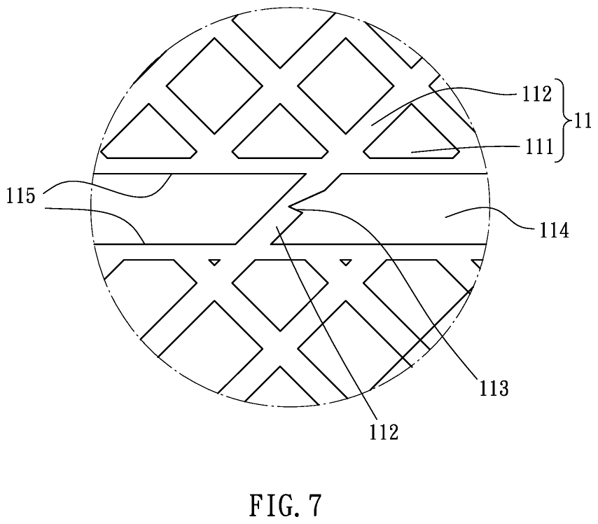

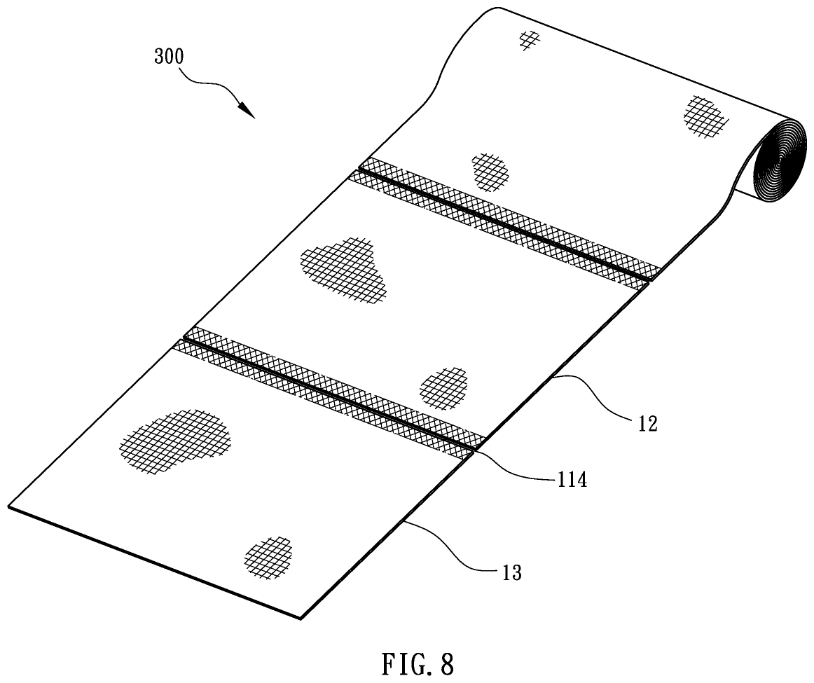

Referring to FIGS. 6, 7 and 8, in one embodiment, the process of the invention further comprises the step of (D) keeping some portions of the tearable line 11 and cutting the remaining portions of the tearable line 11. In one embodiment of the process, a portion of the linking structure 112 and a connection of the base layer 111 and the linking structure 112 are cut. In another embodiment, 40% to 60% (e.g., preferably 48%, 49%, 50%, 51%, or 52%) of a diameter or width of the linking structure 112 is cut to form indentations 113 (see FIG. 7). A groove 114 and two lines 115 along both sides of the groove 114 are formed at the cut position. The lines 115 are capable of preventing the tearable line 11 from being loosened. Thus, it is easy to tear the remaining portions of linking structure 112 from the indentations 113 due to the provision of the groove 114. The torn posterior textile 13 and the anterior textile 12 are stilled connected due to the provision of the remaining linking structure 112. Therefore, it is possible of wrapping the placemat as a cylinder (see FIG. 8) for ease of storage, transportation and use.

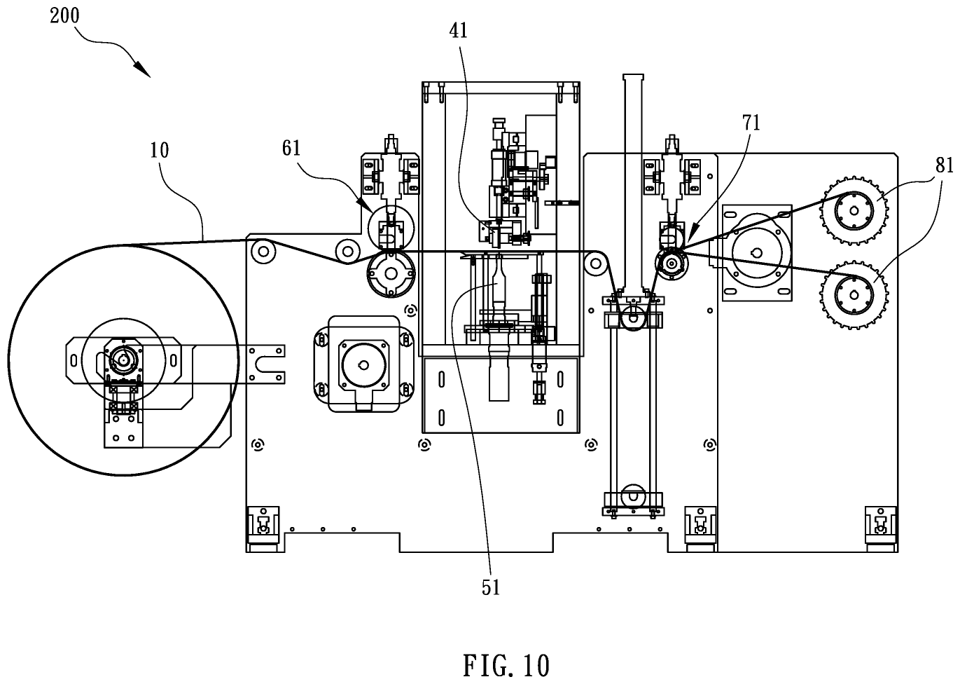

Referring to FIGS. 10, 11, 12 and 13, an apparatus for implementing the process 100 of manufacturing tearable placemats in accordance with the invention comprises a rolling mold 31, a rolling cutter 41, an ultrasonic heater 51, a pair of oppositely disposed entrance rollers 61, a pair of oppositely disposed exit rollers 71, and a pair of oppositely disposed take-up rollers 81.

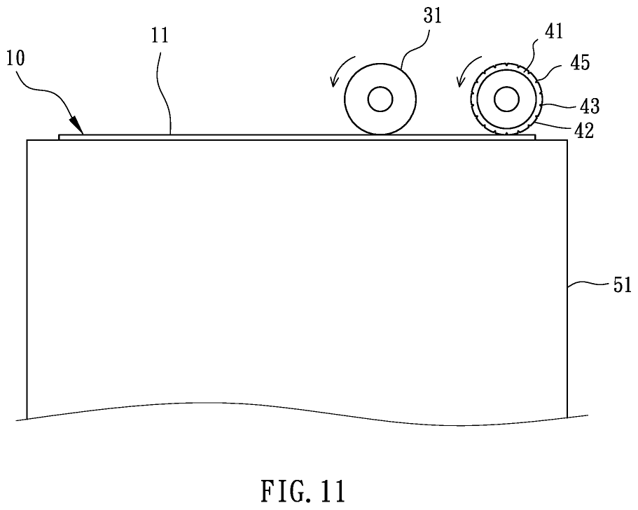

As shown in FIGS. 10 and 11 specifically, the oppositely disposed entrance rollers 61 rotate to press the textile 10 for placemats passing therebetween. Next, the rolling mold 31 and the rolling cutter 41 rotate to press and move the textile 10 for placemats passing a top of the ultrasonic heater 51 forward. Next, the oppositely disposed exit rollers 71 press the textile 10 for placemats passing therebetween. Finally, the textile 10 for placemats is wrapped around the take-up rollers 81.

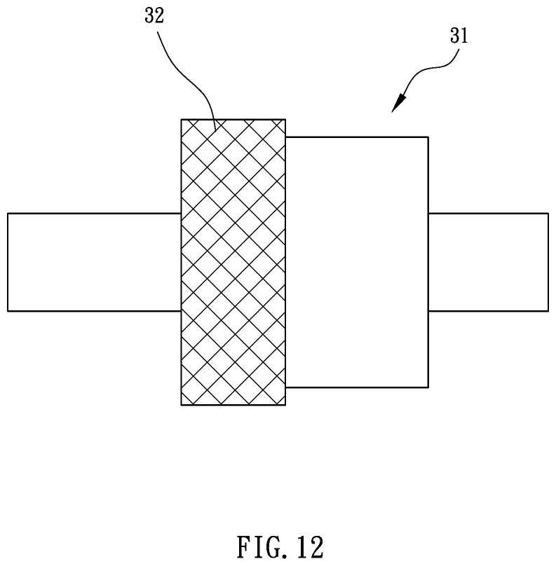

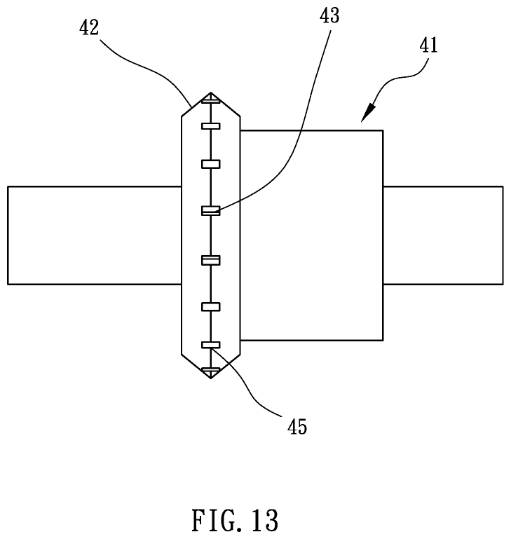

As shown in FIGS. 12 and 13 specifically, the rolling mold 31 includes a knurled structure 32 having the linking structure 112 formed thereon. The rolling cutter 41 includes a circular blade 42 having a plurality of cuts 43 along the edge. In one embodiment, the cuts 43 are equally spaced apart.

The textile 10 for placemats is transferred to the take-up rollers 81 by the entrance rollers 61 and the exit rollers 71 with the steps (B), (C) and (D) being performed on the tearable lines 11 of the textile 10 for placemats passing the top of the ultrasonic heater 51. The steps (B), (C) and (D) are performed repeatedly to transfer the manufactured tearable placemats to the take-up rollers 81.

In response to the tearable lines 11 of the textile 10 for placemats passing the top of the ultrasonic heater 51, the following steps of the process are performed. The rolling mold 31 rotates on the passing tearable lines 11 of the textile 10 for placemats with heat generated by high frequency oscillations of the ultrasonic heater 51 being applied to the rolling mold 31. And in turn, the hot rolling mold 31 melts the tearable lines 11 of the textile 10 for placemats, the molten tearable lines 11 are rearranged to form a different textile 10 for placemats. The step (B) of melting and the step (C) of rearranging are performed in the process. Products of the process are shown in FIGS. 3 and 5 respectively as a result of the steps (B) and (C) performed concurrently.

Also, the rolling cutter 41 rotates on the passing tearable lines 11 of the textile 10 for placemats with heat generated by high frequency oscillations of the ultrasonic heater 51 being applied to the rolling cutter 41. And in turn, the hot blade 42 of the rolling cutter 41 cuts the tearable lines 11 of the textile 10 for placemats to form a plurality of transverse recessed areas. Portions of the linking structure 112 are not cut due to the cuts 43. Thus, these portions of the linking structure 112 are kept. The recessed areas are formed as the grooves 114. Also, two lines 115 along both sides of the groove 114 are formed (see FIG. 7). In one embodiment, the process further comprises the step of forming indentations 113 on the linking structure 112 by edges 45 of the cuts 43.

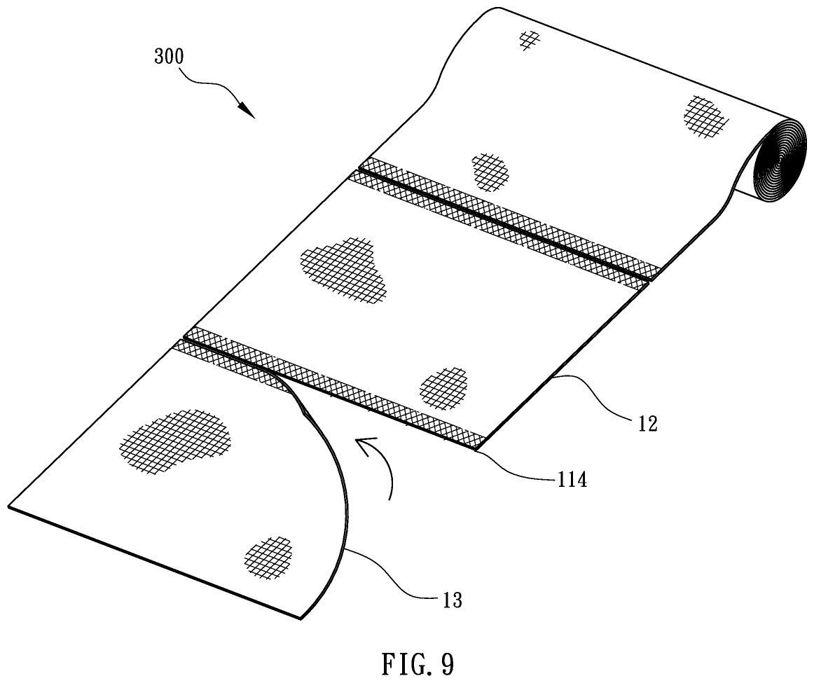

Referring to FIG. 8, a tearable tablecloth roll 300 produced by the process of the invention is shown. The tearable tablecloth roll 300 has one end being pulled out. Referring to FIG. 9, a person may tear the pulled out portion of the tablecloth roll 300 along the groove 114 to break the linking structure 112. As a result, the posterior textile 13 is torn for use.

While the invention has been described in terms of preferred embodiments, those skilled in the art will recognize that the invention can be practiced with modifications within the spirit and scope of the appended claims.

1. A process of manufacturing tearable placemats, comprising the steps of:
(A) selecting a quantity of textile for placemats having a predetermined width, and defining positions of a plurality of tearable lines wherein the textile for placemats in front of the tearable line is defined as an anterior textile and the textile for placemats to the rear of the tearable line is defined as a posterior textile;
(B) melting textile at the position of each of the tearable lines;
(C) rearranging the molten tearable lines to form a textile different from both the anterior textile and the posterior textile; and (D) keeping portions of each of the tearable lines and cutting remaining portions of each of the tearable lines.

2. The process of manufacturing tearable placemats as claimed in claim 1, wherein steps (B) and (C) are performed concurrently.

3. The process of manufacturing tearable placemats as claimed in claim 1, wherein each of the tearable lines comprises a base layer and a linking structure on the base layer, and wherein a portion of the linking structure is kept and a connection of the base layer and the linking structure is cut when the process is performed.

4. The process of manufacturing tearable placemats as claimed in claim 3, wherein a hot mold is rotatably pressed the tearable lines, and wherein a pattern on a surface of the mold is transferred to each of the tearable lines to form the linking structure thereof when the process is performed.

5. The process of manufacturing tearable placemats as claimed in claim 3, wherein 40% to 60% of a diameter or width of the linking structure is cut when the process is performed.

6. The process of manufacturing tearable placemats as claimed in claim 3, wherein the linking structure is a pattern having a plurality of parallel inclined lines.

7. The process of manufacturing tearable placemats as claimed in claim 3, wherein the linking structure is a criss-cross pattern.

8. The process of manufacturing tearable placemats as claimed in claim 3, further comprising:
an ultrasonic heater with the tearable lines of the textile for placemats moveably disposed thereon; and
a rolling mold having a pattern configured to transfer to each of the tearable lines to form the linking structure;
wherein the rolling mold rotates on the passing tearable lines of the textile for placemats with heat generated by high frequency oscillations of the ultrasonic heater being applied to the rolling mold so that the pattern of the rolling mold is configured to transfer to each of the tearable lines of the textile for placemats.

9. The process of manufacturing tearable placemats as claimed in claim 8, further comprising:
a rolling cutter including a circular blade having a plurality of cuts along an edge;
wherein the rolling cutter rotates on the passing textile tearable lines of the textile for placemats with heat generated by high frequency oscillations of the ultrasonic heater being applied to the rolling cutter so that the circular blade is configured to cut the tearable lines of the textile with portions of the linking structure being uncut due to the cuts and the uncut portions of the linking structure being kept.

10. The process of manufacturing tearable placemats as claimed in claim 9, further comprising forming a plurality of indentations on the linking structure by edges of the cuts when the process is performed.
